(19) United States
(12) Patent Application Publication
(10) Pub. No.: US 2017/0082070 A1
(43) Pub. Date: Mar. 23, 2017

(54) Turbopump with a single piece housing and a smooth enamel glass surface

(71) Applicants: Timothy J. Miller, Jupiter, FL (US); Alex Pinera, Jupiter, FL (US); Stephen M. Brooks, Jupiter, FL (US); John W. Appleby, JR., West Palm Beach, FL (US); Timothy G. Leonard, Palm Beach Gardens, FL (US)

(72) Inventors: Timothy J. Miller, Jupiter, FL (US); Alex Pinera, Jupiter, FL (US); Stephen M. Brooks, Jupiter, FL (US); John W. Appleby, JR., West Palm Beach, FL (US); Timothy G. Leonard, Palm Beach Gardens, FL (US)

(21) Appl. No.: 15/227,031

(22) Filed: Aug. 3, 2016

Related U.S. Application Data
(63) Continuation-in-part of application No. 15/173,773, filed on Jun. 6, 2016.
Application No. 15/173,773 is a continuation-in-part of application No. 14/188,938, filed on Feb. 25, 2014, now abandoned.
(60) Provisional application No. 62/286,213, filed on Jan. 22, 2016.
(60) Provisional application No. 62/192,433, filed on Jul. 14, 2015.
(60) Provisional application No. 61/625,473, filed on Apr. 17, 2012.

(51) Int. Cl. F02K 9/46; F04D 29/08; F04D 29/046; F04D 29/02; F04D 29/42; F04D 29/22

(52) U.S. Cl. CPC F02K 9/46; F04D 29/4293; F04D 29/22; F04D 29/046; F04D 29/026; F04D 29/086; F05D 2300/2118

(57) ABSTRACT

A turbopump for a liquid rocket engine in which an oxidizer is pumped, where the turbopump is formed with a single piece rotor within a single piece housing by a metal additive manufacturing process, and where surfaces exposed to the oxidizer is coated with enamel glass to provide a smooth surface over the rough printed surface and to provide burn resistance to the base metal from exposure to the oxidizer such as oxygen. A Mondaloy coating can be used below the enamel glass coating to add additional burn resistance to the base metal.

### CROSS-REFERENCE TO RELATED APPLICATIONS

This application claims the benefit to U.S. Provisional Application 62/286,213 filed on Jan. 22, 2016 and entitled TURBOPUMP WITH A SINGLE PIECE HOUSING AND A SMOOTH ENAMEL GLASS SURFACE. This application is also a CONTINUATION-IN-PART of Ser. No. 15/173,773 filed on Jun. 6, 2016 and entitled APPARATUS AND PROCESS FOR MANUFACTURING A CENTRIFUGAL PUMP WITH A ROTOR WITHIN A SINGLE PIECE HOUSING, which claims the benefit to U.S. Provisional Application 62/192,433 filed on Jul. 14, 2015 and entitled APPARATUS AND PROCESS FOR MANUFACTURING A CENTRIFUGAL PUMP WITH A ROTOR WITHIN A SINGLE PIECE HOUSING. This application is also a CONTINUATION-IN-PART of U.S. patent application Ser. No. 14/188,938 filed on Feb. 25, 2014 and entitled LIQUID ROCKET ENGINE WITH MONDALOY AND GLASS COATING; which claims the benefit to U.S. Provisional Application 61/625,473 filed on Apr. 17, 2012 and entitled LIQUID ROCKET ENGINE WITH MONDALLOY COATING.

### GOVERNMENT LICENSE RIGHTS

None.

### BACKGROUND OF THE INVENTION

Field of the Invention

The present invention relates generally to a centrifugal pump for a liquid rocket engine, and more specifically to a centrifugal pump manufactured with a single piece housing using a metal additive manufacturing process and having a ceramic coating on specific sections to smooth surfaces and prevent an oxidizer from burning.

Description of the Related Art Including Information Disclosed Under 37 CFR 1.97 and 1.98

Metal additive manufacturing process is a form of 3D metal printing in which a part such as an impeller for a turbopump can be printed such as with a metal powder bed fusion process in which a layer of metal powder is laid down and a laser is used to fuse or melt the metal powder to form a solid metal. The metal printing process does not produce a smooth surface as would be found in a casting or a metal machining or metal removal process to form the part.

Prior art manufacturing methods used to produce liquid rocket engine components have historically led to high manufacturing costs. A current challenge in the rocket propulsion industry base is lack of modernization in manufacturing processes and inefficiencies in production. With the low qualities inherent in space propulsion hardware, and an ever increasing drive toward reduced cost, there is an increased interest in design for manufacturability. An optimal balance between commercial best practices and advanced manufacturing techniques could be implemented to meet the future requirements of the rocket propulsion industry. There is potential for significant advancement in cost reduction, design and manufacturing for turbopumps through the application of additive manufacturing (AM).

### BRIEF SUMMARY OF THE INVENTION

A turbopump for a liquid rocket engine with an oxidizer pump and a fuel pump both driven by a turbine and common rotor shaft, where both pumps are formed from a strong base metal such as stainless steel, and where the oxidizer pump includes a coating of a Mondaloy material such as Mondaloy 100 or Mondaloy 200 to from a reaction resistant surface on the base metal with the oxygen being pumped. Any high pressure pump or turbine that requires high strength base material that is used to pump oxygen will have a coating of Mondaloy in order to prevent the reaction of oxygen with the base metal material.

In another embodiment, a substrate exposed to a high temperature such as in a rocket engine turbopump can include a composite coating made of Mondaloy and enamel glass that is co-deposited using a thermal spray process. The Mondaloy coating provides a high strength base material with the properties of a Mondaloy material, while the enamel glass material mixed in with the Mondaloy material provides a burn resistance to the Mondaloy coating.

A turbopump such as a LOX turbopump for a liquid rocket engine is formed using a metal additive manufacturing process in which a single piece impeller is formed within a single piece housing in which the impeller is trapped within the single piece housing. The housing is formed with a fluid inlet and a fluid outlet. The impeller is formed with an axial bore in which a shaft is inserted after the impeller and housing have been formed. Forward and aft bearing support surfaces are machined on to the outer surfaces of the impeller and then two bearings are inserted into the housing and secured by a tie bolt fastened on one end of the shaft. A forward cover plate encloses a forward opening of the housing and a buffer seal encloses an aft opening of the housing.

The cover plate and the buffer seal form support surfaces for outer races of the two bearings. The single piece impeller is formed with forward and aft labyrinth seal teeth all as a single piece, and the housing is formed with seal surfaces for the labyrinth teeth that form forward and aft labyrinth seals between the impeller and housing.

### BRIEF DESCRIPTION OF THE SEVERAL VIEWS OF THE DRAWINGS

FIG. 1 shows a cross section view of a LOX pump of a first embodiment of the present invention.

FIG. 2 shows a cross section view of a LOX pump of a second embodiment of the present invention.

FIG. 3 shows a liquid rocket engine turbo-pump with a coating of Mondaloy material of the present invention.

FIG. 4 shows a close-up section view of a surface of the turbo-pump with the Mondaloy material coating of the present invention.

### DETAILED DESCRIPTION OF THE INVENTION

The present invention is LOX pump used in a liquid rocket engine in which the rotor is formed by a metal additive manufacturing process and formed within a single piece housing that is also formed by a metal additive manufacturing process.

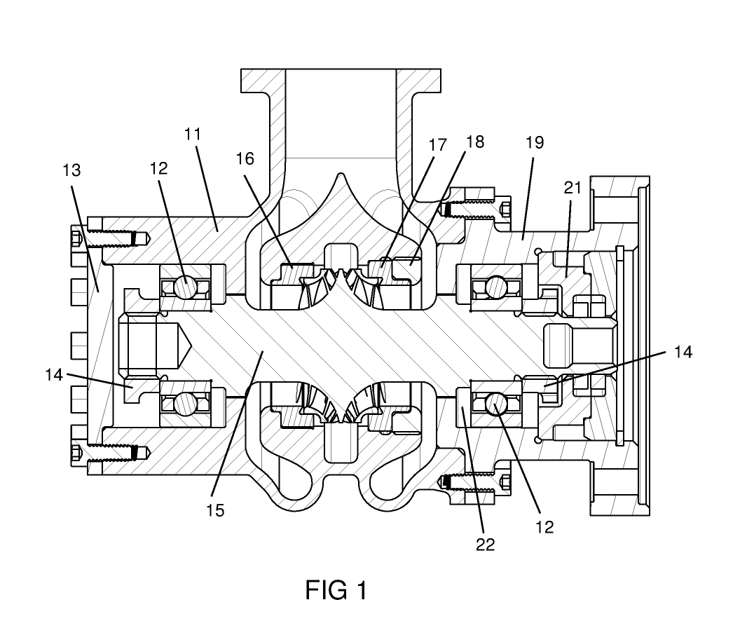

FIG. 1 shows a LOX pump with an extremely efficient design. The LOX pump is formed from only 11 part numbers (not including fasteners) and is very compact. The pump is located in the center and is a back-to-back design similar to the SSME (Space Shuttle Main Engine) High Pressure Oxidizer Turbopump (HPOTP). This reduces/eliminates rotor axial thrust imbalance. There is an inducer in front of each impeller to improve cavitation performance and the impellers are shrouded to minimize secondary flow leakage without requiring extremely tight tolerance. The bearings 12 straddle the impellers 15 and are cooled by recirculating the inlet LOX with the natural pumping of the rotor. The bearings 12 are axially held on the rotor by identical spanner nuts 14. To minimize assembly time and components, the impellers 15 are integral with the shaft. To minimize cost, the two bearings 12 are the same (and same size as the forward fuel pump bearing), the spanner nuts 14 are the same (and same as the fuel pump spanner nut), and the buffer seal 21 is the same as the fuel pump buffer seal. To conserve weight and minimize seals, the inlets and discharge connections are integral 37 degree flared fittings. Finally, since the size is so small and the discharge pressure is low, the rotor design speed is low so the stresses on the parts will be extremely low.

The LOX pump in FIG. 1 includes a cover plate 13 held on by several bolts, a forward seal 16, and aft seal 17, a main housing 11, a nut 17 to secure the forward and aft seals 16 and 17 to the housing 11, an aft housing 19, and a spring 22.

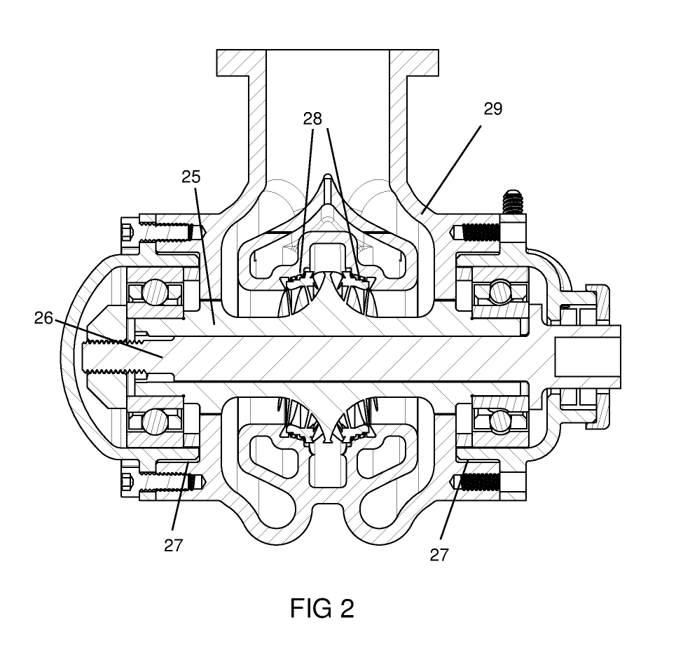

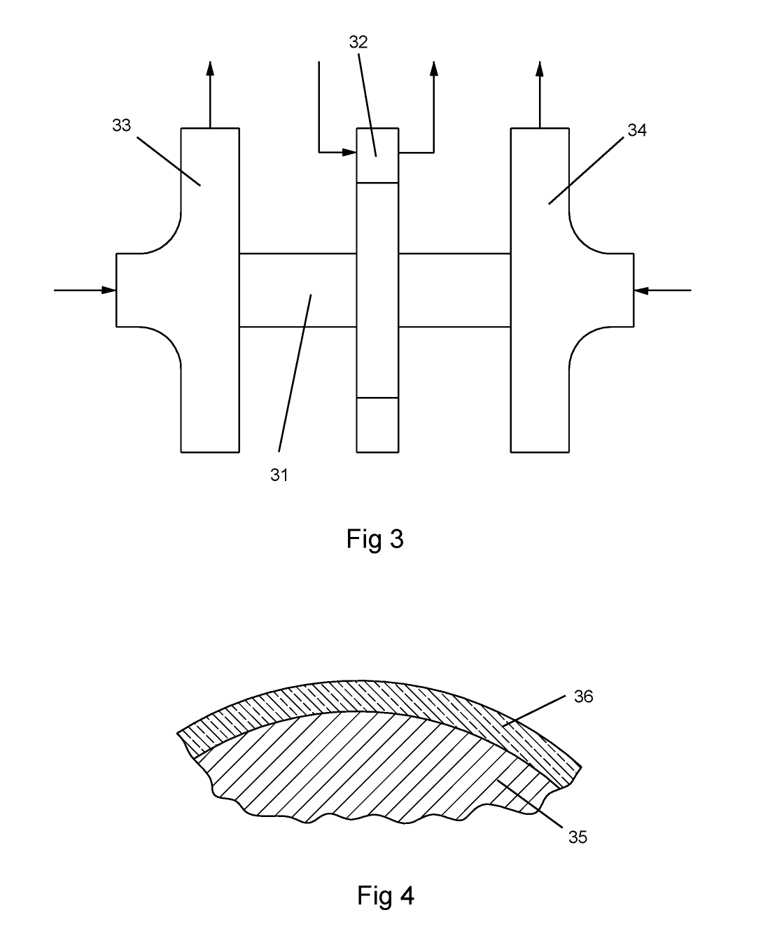

FIG. 2 shows a LOX pump that is formed by a metal additive manufacturing process in which a one-piece rotor is formed within a one-piece housing 29. The impeller 25 and the shaft 26 are simultaneously manufactured within the housing 29, the forward seal and the aft seal and the nut 28 of the FIG. 1 embodiment is eliminated, the requirement to finish machining of the housing for the bearing OD 27 (outer diameter) of the FIG. 1 embodiment is eliminated, and the FIG. 2 embodiment provides for the elimination of all machining operations from the shaft. The FIG. 2 embodiment also eliminates the aft housing and associated interface flange, eliminates the seal and finish machining, and eliminates the screws required in the FIG. 1 embodiment.

In the FIG. 2 design, a double suction impeller is trapped within the single piece housing 29. This is achieved by printing the components simultaneously within a metal additive manufacturing process such as the Selective Laser Melting (SLM) machine. Then, powder and support structure (if required) removal is performed. The bearings are installed on the ends of the shaft. Conventional manufacturing is required for the bearings due to high precision requirements needed. With the exception of the shaft tie-bolt and the shaft seal, all other components are printed on an SLM machine.

Rotor balancing is another critical area. Typically, an assembly balance of the rotor is performed for turbopump rotors. That is, the full rotor is assembled and balanced on a balance machine. Since the rotor is printed inside the single piece housing 29, this method cannot be used without special tooling. In the present invention, a method of trim balancing is used where the rotor is spun up to various high speeds and accelerometers on the housing along with a proximity probe looking at the rotor is used to determine the rotor imbalance. The imbalance is corrected by grinding locations on each end of the shaft.

By printing the pump impeller within a one-piece housing 29, a dramatic reduction in part count, procurement activities, and assembly time is achieved over the prior art, which directly translates into a reduction in recurring cost and lead time. These reductions are estimated to reduce the cost of the LOX pump by approximately 40%. Similarly, if not more (due to the higher part count), reductions will likely result for a hydrogen pump. The turbomachinery for a typical rocket engine accounts for about one-third of the cost of the total engine. Thus, significant reductions in turbomachinery cost have large impacts on the overall cost of the engine.

The present invention is LOX pump used in a liquid rocket engine in which the rotor is formed by a metal additive manufacturing (MAM) process and formed within a single piece housing that is also formed by a metal additive manufacturing process. By printing the pump impeller within a one-piece housing, a dramatic reduction in part count, procurement activities, and assembly time is achieved over the prior art, which directly translates into a reduction in recurring cost and lead time. These reductions are estimated to reduce the cost of the LOX pump by approximately 40%. Similarly, if not more (due to the higher part count), reductions will likely result for a hydrogen pump. The turbomachinery for a typical rocket engine accounts for about one-third of the cost of the total engine. Thus, significant reductions in turbomachinery cost have large impacts on the overall cost of the engine.

The metal printing process produces a relatively rough surface on the parts. Thus, the present invention also applies a coating of an enamel glass to form a smooth surface that functions to increase the efficiency of the pump. Because the single piece rotor is formed at the same time within a single piece housing, a machining tool that would form a smooth surface cannot be used because of lack of space to insert the tool. Thus, an enamel glass coating can be applied over the required surfaces while the rotor and even the housing is rotating to form a smooth surface. The enamel glass coating would also provide a burn resistance to the pump surfaces that would be exposed to the liquid oxygen. Because of the use of the burn resistant coating, Inconel 718 can be used as the base metal material which is strong enough for use as the rotor material and cheap enough to keep costs down. Inconel 718 is a nickel based superalloy which retains high strength at elevated temperatures and has high strength up to 1,300 degrees F., good cryogenic ductility, and good weldability.

The enamel glass coating is an ambient temperature applied coating using a spray or a brush to apply to selected surfaces. Or, the entire turbopump with the rotor and the housing can be submerged within a slurry of the liquid coating material to apply the coating. A masking tape can be used to mask surfaces where the coating is not to be applied.

The turbopump is formed using a metal powder bed fusion process in which thin layers of powder are applied to a platen, and then a laser is used to fuse or melt the powder to form a solid metal material. Subsequent layers of the powder are laid down and then selectively fused by the laser to build the parts. The turbopump is built up along the rotational axis of the turbopump in a vertical direction with surfaces between the rotor and the housing for the forward and aft bearings to be placed. This way both the single piece housing and the single piece rotor can be formed.

After the rotor and housing has been formed by the powder bed fusion process, the turbopump is placed in a horizontal position and masking tape used over surfaces that will not have the enamel glass coating applied. The enamel glass coating is formed over selected surfaces by using a spray nozzle or a brush to apply the coating while the rotor is slowly rotating within the housing to spread the coating. The housing can also be rotated. The turbopump is then fired to harden the glass coating. The enamel glass coating is applied over the rough surface of the printed part to not only smooth the surface, but to add protection against heat, against oxidation, against erosion, and even against damage from a foreign object strike (FOD). Any masking tape used can be removed before the firing process. After the coating has been hardened, the two bearings are inserted and the open ends of the housing are enclosed with cover plates.

The rotor 15 and the housing 11 are formed with bearing support surfaces that can be machined afterwards because the bearing surfaces are located close to the two open ends of the single piece housing. Bearings 12 can then be inserted into position to rotatably support the rotor 15 within the housing 11 and the open end or ends of the housing closed by securing a cover plate 13. The opposite end would be connected to a driving mechanism such as an input shaft from a turbine.

The rocket engine is formed from a turbo-pump that is used to pump both a liquid fuel and a liquid oxidizer to a common combustion chamber. The liquid oxidizer would be liquid oxygen and the liquid fuel would be liquid hydrogen. A common shaft 31 is driven by a turbine 32 with the fuel pump 33 on one end and the oxidizer pump 34 on the opposite end. The oxidizer pump 34 and the fuel pump 33 are typically centrifugal pumps because of the high pressures obtained. To prevent cavitation in the centrifugal pumps, an inducer is used upstream of the centrifugal pump to increase the pressure so as to eliminate cavitation in the higher pressure pump. To prevent the combustion resistance in the presence of high temperature and high pressure liquid or gaseous oxygen, the surfaces 35 of the pumps that are exposed to the oxygen are coated with a Mondaloy material such as the Mondaloy 100 or 200 materials 36. Thus, the turbo-pump can be constructed with the prior art metal materials for strength and light weight such as stainless steels or Inconel, but have the combustion resistance to the high temperature and high pressure liquid or gaseous oxygen due to the Mondaloy coating on its surfaces on which the liquid or gaseous oxygen would make contact. No Mondaloy coating is required on the liquid hydrogen fuel pumps. The Mondaloy material is disclosed in US 2010/0266442 A1 by Jacinto et al. published on Oct. 21, 2010 and entitled BURN-RESISTANT AND HIGH TENSILE STRENGTH METAL ALLOYS the entire disclosure which is incorporated herein by reference.

The Mondaloy coating can also be used on other high pressure pumps or turbine that are exposed to liquid or gaseous oxygen. Because of the high pressure, the base metal material must be a high strength material such as stainless steel. Certain high strength materials are very reactive to oxygen. If the pump or turbine is exposed to oxygen, then the Mondaloy coating on the surfaces that are exposed to the oxygen will provide for the high strength required while also protecting the base material from reacting to the oxygen.

In another embodiment of the present invention, a glass powder is mixed in with the Mondaloy powder to produce a coating formed from a composite of Mondaloy and enamel glass that will produce a coating having properties of the Mondaloy material and with a burn resistance that is produced with the enamel glass material. When the glass powder is fired, it becomes an enamel.

The Mondaloy and enamel glass coating is a multiple component surface coating of Mondaloy and an enamel glass that is co-deposited using a thermal spray process. The powder would be made of the enamel glass composition. The two constituents can be pre-blended or independently injected into a thermal plumb to allow for functional grading of the coating. Use of the fired enamel glass coating with the Mondaloy material has been shown to arrest burning of the metal substrate. Thus, use of the enamel glass constituent processed as a powder and deposited using thermal spray would enhance the burn resistance of the Mondaloy material in the coating.

In another version, a surface can be created by coating a multiple component surface coating of Mondaloy and an oxide that is co-deposited using a thermal spray process. The two constituents can be pre-blended or independently injected into the thermal plumb to allow for functional grading of the coating. The addition of the oxide would enhance the burn resistance of the Mondaloy coating.

In still another version, a surface can be created with high oxide content Mondaloy coating through adjustment of the thermal spray parameters. Mondaloy powder is produced with little or no oxide impurities. Thermal spraying in air creates oxides in the coating deposit due to the interaction of the metal powder with a thermal heating source. Thermal spray parameters can be adjusted to regulate the oxide content of the coating deposit. The addition of the oxide content will enhance a burn resistance of the Mondaloy coating.

Instead of the glass powder, an oxide powder can be used to produce similar properties for the coating containing Mondaloy to resist burning. Aluminum oxide or yttria stabilized zirconia can be added as the oxide to the Mondaloy powder to create the coating. Combinations of these three materials (Mondaloy, glass and oxide powder) can be used to produce the coating. Thus, a coating can be produced from Mondaloy powder and glass powder, or from Mondaloy powder and oxide powder, or from Mondaloy powder and glass powder and oxide powder.

In still another embodiment of the present invention, a burn resistant coating that uses enamel glass fired with Mondaloy powder can be produced that will allow for higher operating temperatures (prevent thermal creep) and better manage the coefficient of thermal expansion mismatch. This embodiment will add Mondaloy powder after spraying on enamel slurry before firing the composition. The attributes of the coating are burn resistance, low cost, and easy application to complex geometry parts or internal passages such as in air cooled airfoils.

We claim the following:

1. A liquid rocket engine oxidizer turbopump comprising:
a housing with a liquid oxygen inlet and a liquid oxygen outlet;
an impeller rotatable within the housing;
a forward bearing and an aft bearing to rotatably support the impeller within the housing;
both the housing and the impeller are formed as a single piece with the impeller trapped within the housing; and,
surfaces of the oxidizer pump exposed to an oxidizer during pumping having a composite coating of enamel glass to prevent reaction of the oxidizer.

2. The liquid rocket engine oxidizer turbopump of claim 1, and further comprising:
the surface of the oxidizer pump includes a coating of Mondaloy material below the enamel glass coating.

3. The liquid rocket engine oxidizer turbopump of claim 2, and further comprising:
The Mondaloy coating is Mondaloy 100 or Mondaloy 200.

4. The liquid rocket engine oxidizer turbopump of claim 1, and further comprising: The oxidizer pump is a centrifugal pump.

5. The liquid rocket engine oxidizer turbopump of claim 2, and further comprising:
the composite coating of Mondaloy material and enamel glass is a mixture of Mondaloy powder and enamel glass powder that is deposited using a thermal spray process.

6. The liquid rocket engine oxidizer turbopump of claim 2, and further comprising:
the Mondaloy and glass includes an oxide in the coating.

7. The liquid rocket engine oxidizer turbopump of claim 2, and further comprising:
the oxide is one of aluminum oxide or yttria stabilized zirconia.

8. An oxidizer turbopump comprising:
a single piece housing with an oxidizer inlet and an oxidizer outlet and a forward opening and an aft opening;
the single piece housing having an inner minimum diameter;
a single piece impeller having a maximum outer diameter greater than the inner minimum diameter of the single piece housing;
a forward bearing and an aft bearing to rotatably support the single piece impeller within the single piece housing; and,
surfaces of the oxidizer pump exposed to an oxidizer during pumping having a coating of enamel glass to prevent reaction of the oxidizer.

9. The oxidizer turbopump of claim 8, and further comprising:
the single piece impeller includes an axial bore;
a shaft is inserted within the axial bore; and,
a shaft tie bolt is threaded on one end of the shaft to secure the forward and aft bearings between the housing and the impeller.

10. The oxidizer turbopump of claim 8, and further comprising:
a forward cover plate encloses a forward opening of the housing; and,
an aft buffer seal encloses an aft opening of the housing.

11. The oxidizer turbopump of claim 10, and further comprising:
the forward cover plate forms a support surface for the forward bearing; and,
the aft buffer seal forms a support surface for the aft bearing.

12. The oxidizer turbopump of claim 8, and further comprising:
a Mondaloy coating is used below the enamel glass coating.
